(19) United States
(12) Patent Application Publication
(10) Pub. No.: US 2019/0272581 A1
(43) Pub. Date: Sep. 5, 2019

(54) ORDER INFORMATION DETERMINATION METHOD AND APPARATUS

(71) Applicant: Alibaba Group Holding Limited, George Town (KY)

(72) Inventors: Jiajia Li, Hangzhou (CN); Lei JIAO, Hangzhou (CN)

(73) Assignee: Alibaba Group Holding Limited, George Town (KY)

(21) Appl. No.: 16/418,877

(22) Filed: May 21, 2019

Related U.S. Application Data
(63) Continuation of application No. PCT/CN2018/077889, filed on Mar. 2, 2018.

(30) Foreign Application Priority Data
Mar. 7, 2017 (CN) 201710132344.1

(51) Int. Cl. G06Q 30/06; G06K 9/00; G06F 3/01; G06Q 20/32; G06K 7/10

(52) U.S. Cl. CPC G06Q 30/0635; G06Q 30/0639; G06K 7/10445; G06F 3/017; G06Q 20/3278; G06K 9/00288

(57) ABSTRACT

The present disclosure provides a method for determining a user's order in a physical store, without requiring the user to queue for checkout and have their order manually created. A service management system performs a gesture recognition on the user, as well as receives location information of a commodity. The service management system then determines whether the user is leaving a shopping area with the commodity, and adds information corresponding to the commodity to the user's order.

### CROSS-REFERENCE TO RELATED APPLICATIONS

This application is a continuation of PCT Application No. PCT/CN2018/077889, filed on Mar. 2, 2018, which claims priority to Chinese Patent Application No. 201710132344.1, filed on Mar. 7, 2017, and each application is hereby incorporated by reference in its entirety.

### TECHNICAL FIELD

The present disclosure relates to the field of Internet technologies, and in particular, to an order information determination method and apparatus.

### BACKGROUND

After selecting commodities in a conventional physical store, consumers need to queue up at checkout counters to pay for the commodities, and the checkout staffs use computers to pay for the commodities. However, this payment process is often inefficient, and it is likely to take a long waiting time. To improve payment efficiency, in the existing technology, when a consumer selects and purchases commodities, a selection and purchase process of the consumer can be analyzed in real time based on a technology such as computer vision, to determine commodities taken by the consumer and commodities put back by the consumer, so as to modify and determine order information, that is, a bill list of the consumer. However, in the previous analysis process, there are many factors that can cause inaccurate determination, for example, inaccurate determination occurs when many people simultaneously take commodities on a lower shelf, or an identification device is shielded and makes an erroneous decision when the consumer put commodities with extremely high similarity back to wrong places. All of these factors can cause inaccurate determination of the order information, and affect commodity payment.

### SUMMARY

In view of this, the present disclosure provides an order information determination method and apparatus, to determine order information of commodities more quickly and accurately, so that a commodity on an order is associated with a consumer.

The present disclosure is achieved by using the following technical solutions:

According to a first aspect, an order information determination method is provided, where the method is used to determine an association between a user and a commodity selected and purchased by the user, and the method includes: performing human gesture recognition on a user to obtain gesture data of the user; positioning a commodity to obtain location information of the commodity; determining whether a gesture of the user is taking the commodity based on the gesture data and the location information; and adding the commodity to an order of the user if a determination result is that the user takes the commodity.

According to a second aspect, an order information determination apparatus is provided, and the apparatus includes: a gesture recognition module, configured to perform human gesture recognition on a user to obtain gesture data of the user; a commodity positioning module, configured to position a commodity to obtain location information of the commodity; an information processing module, configured to determine whether a gesture of the user is taking the commodity based on the gesture data and the location information; and an order processing module, configured to add the commodity to an order of the user if a determination result is that the user takes the commodity.

According to the order information determination method and apparatus in the present disclosure, order information of a consumer can be quickly and accurately determined, and payment of an order are automatically completed. After completing shopping, the consumer can directly leave without queuing up at a checkout counter for payment, thereby improving shopping efficiency and providing fairly good shopping experience.

### BRIEF DESCRIPTION OF DRAWINGS

FIG. 1 illustrates an area layout of a convenience store, according to an implementation of the present disclosure;

FIG. 2 is a schematic diagram illustrating a more detailed layout inside a convenience store, according to an implementation of the present disclosure;

FIG. 3 is a schematic structural diagram illustrating a computing device, according to an implementation of the present disclosure;

FIG. 4 is a flowchart illustrating an order information determination procedure, according to an implementation of the present disclosure;

FIG. 5 is a schematic structural diagram illustrating an order information determination apparatus, according to an implementation of the present disclosure; and

FIG. 6 is a flowchart illustrating an example of a computer-implemented method for order information determination, according to an implementation of the present disclosure.

### DESCRIPTION OF IMPLEMENTATIONS

In people's daily life, shopping in supermarkets, shopping malls, convenience stores, etc., is a common shopping behavior. After selecting and purchasing commodities, a customer needs to queue up at a checkout counter at an exit to pay for the commodities, which is time-consuming and inconvenient. To improve shopping efficiency, a shopping management system can be used to automatically identify a commodities selected and purchased by a consumer during shopping, determine an association relationship between the consumer and the commodities selected and purchased by the consumer, and automatically push a corresponding bill to the consumer for self-service payment. As such, the consumer does not need to queue at the exit to pay for the commodities, thereby improving shopping efficiency.

An important factor for implementing the previous method is to determine an association relationship between a consumer and commodities selected and purchased by the consumer, and a bill corresponding to the consumer can be obtained only after the association relationship is determined. In the present disclosure, this association relationship can be referred to as “order information”, that is, commodities selected and purchased by a consumer. An order information determination method provided in the present disclosure is intended to determine the order information simply and accurately, to assist in quick payment.

A processing process of the order information determination method in the present disclosure is described below by using an example that a consumer shops in a convenience store. However, the method can also be applied to another scenario, such as a scenario in which an association relationship between a person and an article needs to be determined, for example, shopping in a supermarket, shopping in a shopping mall, inventory monitoring for a warehouse (which person took which thing from the warehouse), and book management for library (which user borrowed which book).

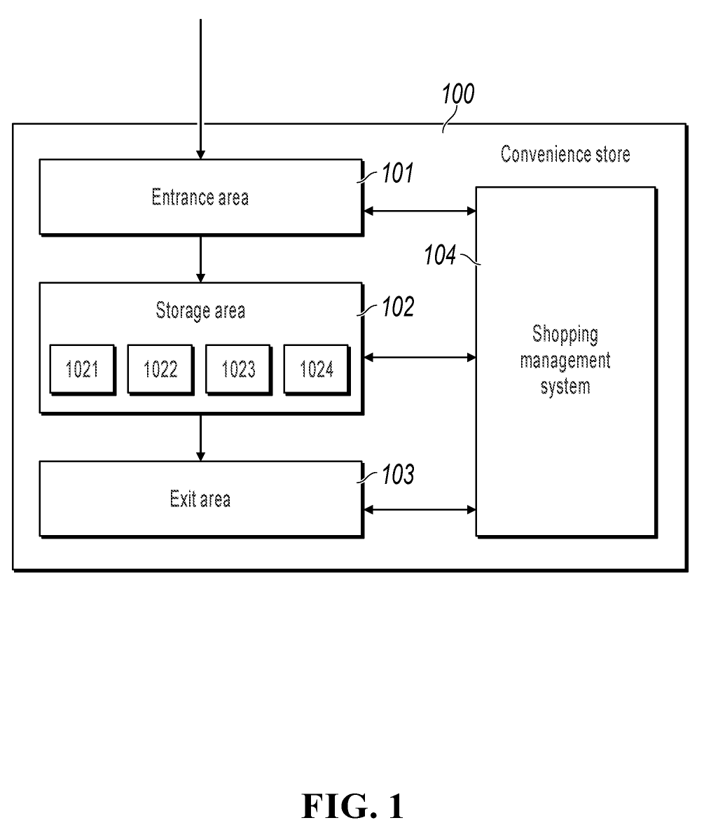

FIG. 1 illustrates an area layout of a convenience store. As shown in FIG. 1, a convenience store 100 can include an entrance area 101, a storage area 102, and an exit area 103. A consumer can enter the convenience store 100 from the entrance area 101, and select and purchase a commodity in the storage area 102. After completing the selection and the purchase, the consumer exits the convenience store from the exit area 103. The storage area 102 can store many commodities. For example, 1021 to 1024 illustrated in FIG. 1 are commodities in the convenience store, and can include fruits, drinks, milk, bread, etc. FIG. 1 illustrates only part of the commodities, and the storage area 102 can actually include more commodities. The layout of the convenience store shown in FIG. 1 is a functional area division, and is not an actual physical area division. In an example, a plurality of entrance areas 101, storage areas 102, and exit areas 103 can be arranged together through merging instead of being arranged separately.

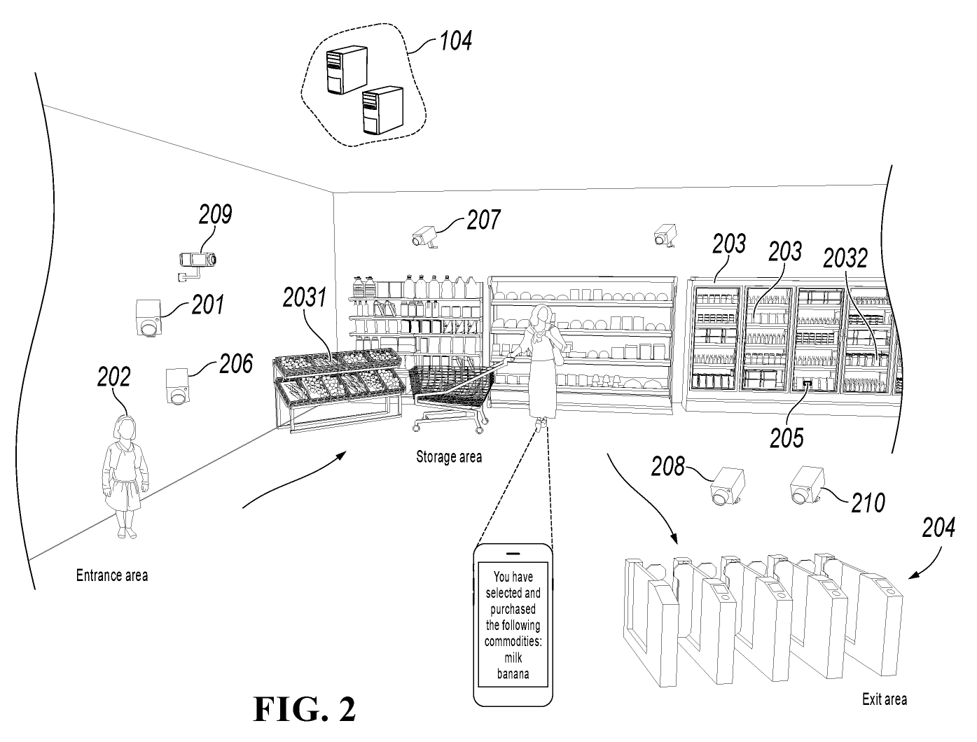

The convenience store 100 in FIG. 1 can further include a shopping management system 104. The shopping management system 104 can communicate and interact with the entrance area 101, the storage area 102, and the exit area 103. FIG. 2 illustrates the layout inside the convenience store in more details. For example, some facial recognition devices 201 can be placed in the entrance area 101 in the convenience store 100. When a consumer 202 enters the convenience store, the facial recognition device 201 can automatically collect facial recognition data of the consumer 202. For example, the facial recognition device 201 can collect images of the consumer in the entrance area, search the image by using a specific policy to determine whether the image includes a face, and return a location, a size, and a gesture of the face if the image includes the face. In addition, the facial recognition device 201 can perform preprocessing and feature extraction on a facial image to obtain facial recognition data. Some shelves 203 can be placed in the storage area 102, and many commodities can be placed on the shelves 203, for example, bananas 2031, and milk 2032 shown in FIG. 2. For example, when selecting and purchasing a commodity, the consumer can hold the commodity with a hand, or hold the commodity with an arm, that is, the consumer can carry the commodity by using a body part. After completing shopping, the consumer can go to the exit area of the convenience store, and exit the convenience store through an exit channel 204 without queuing up for payment. Usually only one person can pass through one exit channel 204 in sequence.

In an example, in the present disclosure, a radio frequency identification (RFID) label can be attached to each commodity, for example, an RFID label 205 attached to a commodity on the shelf 203 in FIG. 2. Labels on different commodities include different information, and the labels include identification information of the commodities.

As shown in FIG. 2, a plurality of readers configured to receive an RFID label signal can be further installed on a wall, a roof, etc. of the convenience store, for example, a reader 206 disposed in the entrance area, a reader 207 disposed in the storage area, and a reader 208 disposed in the exit area. The reader can transmit received RFID label information to the shopping management system 104, and the shopping management system 104 can store and process the information. In addition, monitoring devices such as cameras 209 can be further disposed in the convenience store, and these monitoring devices can be configured to perform video monitoring in the store. Monitoring information can also be transmitted to the shopping management system 104. The shopping management system 104 can further transmit information in the system to another device for display by using a network device such as a wireless antenna installed in the store. For example, the shopping management system 104 can transmit the information to a smartphone carried by the consumer, so that the consumer can conveniently check the information obtained by the shopping management system by using the mobile phone.

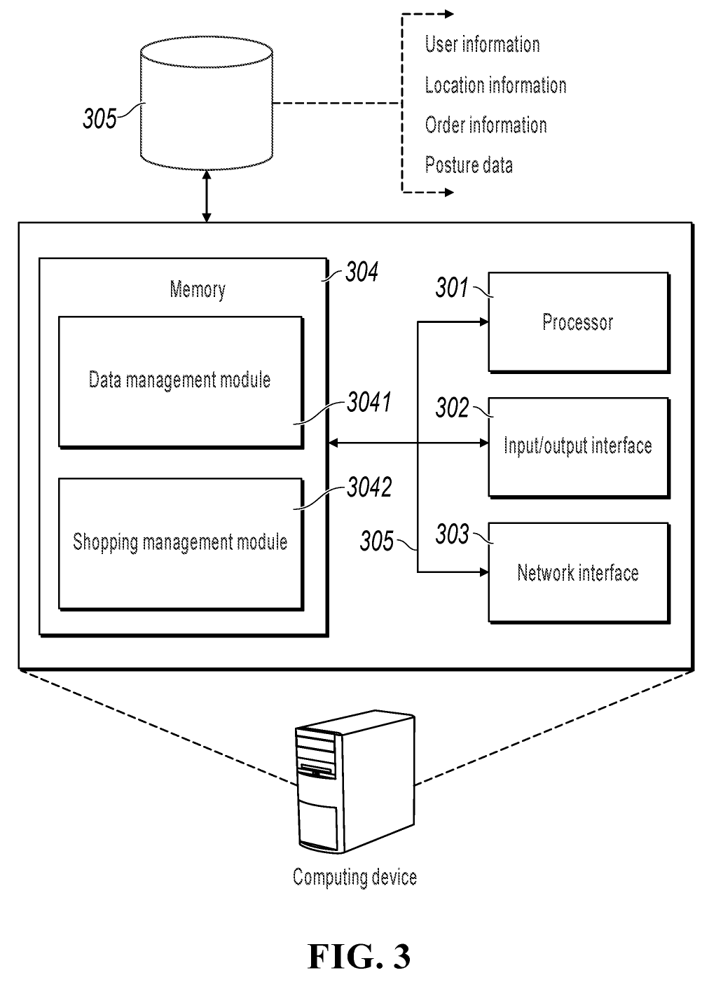

The shopping management system 104 can be a local or remote server system, and can include a plurality of computing processing devices. For example, two computing devices are illustrated in FIG. 2, and there can have more computing devices in actual implementation. As shown in FIG. 3, a computing device can include a processor 301, an input/output interface 302, a network interface 303, and a memory 304. The processor 301, the input/output interface 302, the network interface 303, and the memory 304 can be connected to and communicated with each other by using a bus 305. FIG. 3 illustrates only some components, and an actual computing device can include more or fewer components. The memory 304 can further include a data management module 3041 and a shopping management module 3042. These modules can be in a form of hardware, software, etc., and can be computer-executable programs when they are in the form of software.

For example, the computing device can receive, through the network interface 303, information transmitted by a device such as the RFID label or the camera in the convenience store, and process the information (which is described in detail in a subsequent example), for example, location information of a commodity obtained through positioning by using the RFID label, or member ID information transmitted by the consumer. The processor 301 can process the received information by executing an instruction of the shopping management module 3042, to obtain some latest data, for example, information about a new consumer who enters the convenience store, commodity location information, gesture data of a user, or order information of a consumer. In addition, the processor 301 can update the data to a database 305 by executing an instruction of the data management module 3041.

In an example, the database 305 can store data, for example, the data can include user information, location information, order information, and gesture data. The user information can be member IDs of some users registered with the shopping management system, the location information can be information obtained by positioning a commodity that is described in a subsequent example, the order information can be information about commodities selected and purchased by a consumer, and the gesture data can be data obtained by performing dynamic human gesture recognition on a user that is described in a subsequent description. In addition, the computing device can update the information based on latest received data. For example, the computing device can update the user information when there is a new registered user, can update the location information of the commodity during real-time positioning for the commodity, and can further update the order information based on a commodity change in an order. In addition, the computing device can further output data in the database. For example, the computing device can extract the order information from the database and send the order information to another device such as a mobile phone of a consumer, so that the consumer can check the information.

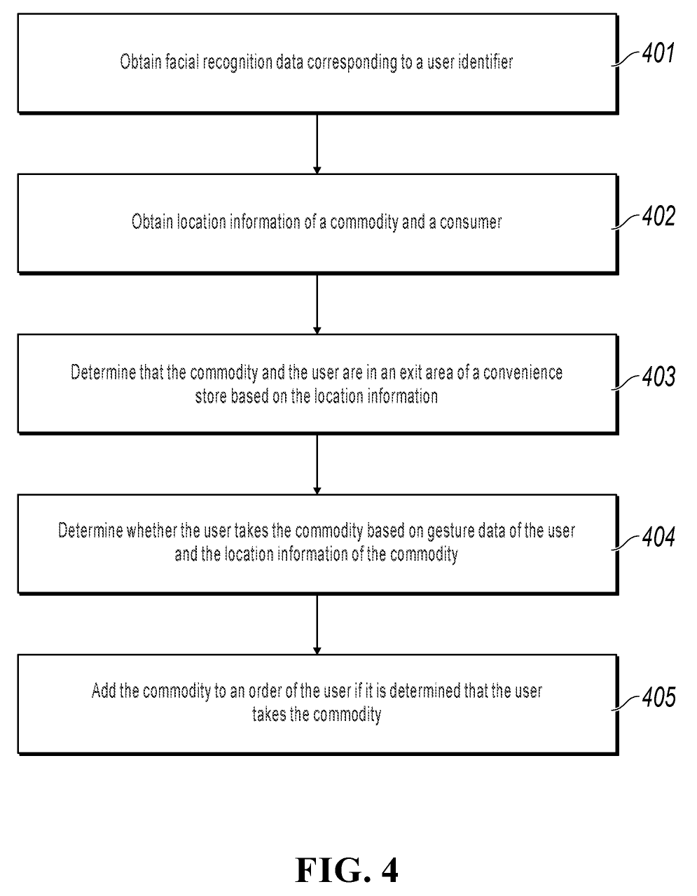

FIG. 4 illustrates an order information determination procedure. When a consumer enters a convenience store to select and purchase a commodity, the consumer can enter the convenience store from the entrance area, can select and purchase commodities on the shelves during shopping, and can hold the commodity with a hand or an arm, and directly leave the convenience store from the exit area after completing the selection and the purchase. In this process, the shopping management system can perform the procedure in FIG. 4 to determine order information, that is, determine commodities selected and purchased by the consumer in the convenience store.

In step 401, when the consumer enters the convenience store to select and purchase a commodity, the consumer can enter a member ID in the entrance area. For example, the user can generate a two-dimensional code identifying identity information by using shopping software installed on a smartphone. The shopping software can be client software in the shopping management system, and the user has entered the member ID registered with the client software to the mobile phone. The member ID can be referred to as a user identifier. Alternatively, the user can enter the member ID through NFC by using an intelligent device such as a band, and the intelligent device has been associated with the member ID. The client software can further upload the obtained member ID to the shopping management system.

In addition, in the entrance area, the facial recognition device 201 can perform facial recognition on the user, and transmit obtained facial recognition data to the shopping management system. As such, the shopping management system can receive information about binding between the facial recognition data and the member ID used as the user identifier, which is equivalent to learning of a member ID corresponding to a consumer having a facial feature, and the shopping management system can store the mapping relationship in the database 305.

When the user enters the storage area to select and purchase a commodity, in the entire convenience store, an RFID label attached to a commodity can be located by using the RFID reader 208, ect. installed in the store. For example, the reader 208 can receive a label signal sent by the RFID label on the commodity. The label signal can include commodity information. For example, the commodity information can include a commodity code uniquely identifying the commodity. In step 402, the reader 208 can transmit the label signal to the shopping management system, and the shopping management system can perform positioning calculation based on the label signal to obtain location information of the positioning label on the commodity. For example, with reference to FIG. 3, the processor 301 on the computing device can execute an executable code in the shopping management module 3042, perform positioning calculation based on the label signal, and store the location information obtained through calculation in the database 305 by executing an executable code in the data management module 3041. In the present step, positioning can be performed based on a common RFID positioning technology. In addition, some facial recognition devices can be installed in a selection and purchase area in the convenience store. These devices not only can detect facial features, but also can locate persons to obtain location information of consumers in the store.

In step 403, the shopping management system can determine, based on the location information, that the commodity and the user are in the exit area of the convenience store.

In step 404, the shopping management system can perform human gesture recognition on the user by using the facial recognition device 210 installed in the exit area, to obtain gesture data of the user, and position the commodity label by using the reader 208 in the exit area, to obtain location information of the commodity. An input video can be analyzed to recognize a human gesture, for example, whether a person puts hands in front of the chest or hangs the hands, or whether the person holds arms tightly. The gesture data of the user is equivalent to a location relationship between all parts of a human body.

In this example, whether a gesture of the user is taking the commodity can be determined based on the gesture data and the location information. For example, whether the commodity can be taken by using a gesture of a user part corresponding to the location information of the positioning label can be determined based on the gesture data. Assume that the user part corresponding to a location of the positioning label is the user's chest, but the gesture data of the user shows that there is nothing in front of the chest, and the user hangs the hands, the commodity is not held by the user. In an opposite example, assume that the user part corresponding to the location of the positioning label is in a side thigh part of the user, and it is determined, based on the gesture data, that the user hangs the hand and the hand of the user is also in this area, it can be determined that the user holds the commodity with the hand.

In step 405, commodity information of the commodity can be added to an order of the user if a determination result is that the user takes the commodity. In addition, in the exit area, the facial recognition device obtains facial recognition data again, obtains a member ID corresponding to the data, and adds the commodity to the order corresponding to the member ID. If the corresponding member ID fails to be obtained through facial recognition, another method can be attempted to enter the member ID, for example, the member ID can be entered through a two-dimensional code or NFC. In commodity detection, a commodity label not belonging to the convenience store can be excluded.

During order information determination in the present disclosure, the gesture data of the user is recognized and the commodity is positioned, and then an order to which the commodity belongs is determined by using a location relationship between a gesture and the commodity. This method is more accurate in determining an order. For example, even if many people simultaneously take commodities on a shelf, a location relationship between a commodity and a user gesture still needs to be determined, and an order is determined only when a commodity satisfies a commodity taking gesture. For another example, even if the user places commodities with a high similarity in wrong places, there is no effect on determination of a final commodity and a user gesture. This method can be more accurate in determining an order to which a commodity belongs without effect of many misleading factors.

An order ownership of a commodity can be determined based on a distance between the commodity and a cart at any time after the user enters the convenience store. In some instances, after the member ID and the bound facial recognition data are obtained in the entrance area, recognition is not performed during commodity selection and purchase in the storage area. Instead, a location relationship between a user gesture and the commodity can be recognized in the exit area, so as to determine an order to which the commodity belongs.

In addition, when adding the commodity to the order of the user, the shopping management system can update order information data in the database 305, that is, selected and purchased commodities in the order of the user are updated. In addition, the shopping management system can further send the order information to the smartphone of the user. As shown in FIG. 3, the client software installed on the smartphone of the user can have a cart information interface, and the cart information interface can display a list of commodity order information. The user can see the following information: “You have selected and purchased the following commodities: bananas and apples”, so that the user can know a change in the order at any time. The cart information interface can further display a quantity of commodities selected and purchased by the user, or can further display more other commodity information, such as places of production of the commodities. Use of other auxiliary determination technologies is not excluded in the present disclosure to assist in determining the order information, for example, a plurality of sensors can be used for assistance.

After the order information is determined, the shopping management system can generate a bill to be paid based on the order, and push the bill to be paid to the user. The user can pay for the bill in a fund account corresponding to the member ID. The fund account of the user needs to have sufficient money, or can be connected to another payment channel having sufficient money that can be used to pay for the order. Otherwise, the user possibly is restricted to leave with a commodity beyond a payment capability or a warning device can be triggered to give a warning.

In the example in the present disclosure, an RFID label is attached to a commodity, and the commodity is positioned by using the RFID label. In specific implementation, this is not limited thereto, and the commodity can be positioned in another positioning method. Another positioning label can be attached to the commodity, and the commodity is positioned by using another corresponding positioning technology.

According to the method in the present disclosure, order information of a consumer can be quickly and accurately determined, and payment of an order are automatically completed. After completing shopping, the consumer can directly leave without queuing up at a checkout counter for payment, thereby improving shopping efficiency and providing fairly good shopping experience.

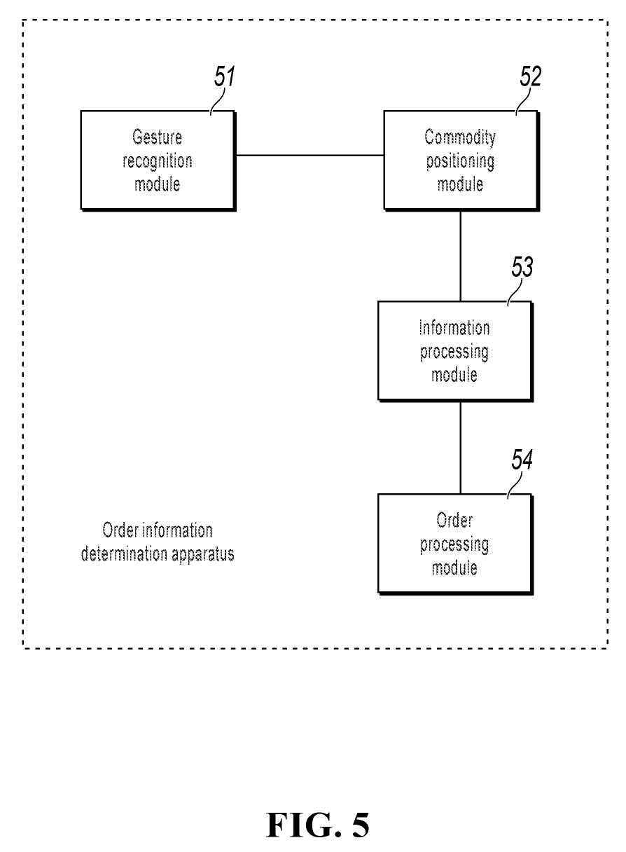

The present disclosure further provides an order information determination apparatus. The apparatus can be the shopping management module in FIG. 3 or the shopping management system in FIG. 1. As shown in FIG. 5, the apparatus can include a gesture recognition module 51, a commodity positioning module 52, an information processing module 53, and an order processing module 54.

The gesture recognition module 51 is configured to perform human gesture recognition on a user to obtain gesture data of the user.

The commodity positioning module 52 is configured to position a commodity to obtain location information of the commodity.

The information processing module 53 is configured to determine whether a gesture of the user is taking the commodity based on the gesture data and the location information.

The order processing module 54 is configured to add the commodity to an order of the user if a determination result is that the user takes the commodity.

In an example, the information processing module 53 is configured to: position a positioning label on the commodity based on a label signal sent by the positioning label, to obtain location information of the positioning label, where the label signal includes commodity information of the commodity; and determine, based on the gesture data of the user, whether the commodity can be taken by using a gesture of a user part corresponding to the location information of the positioning label.

In an example, the positioning label is a radio frequency identification RFID label.

In an example, the information processing module 53 is configured to determine whether the gesture of the user is taking the commodity when it is determined that the commodity and the user are in an exit area based on location information of the commodity and the user obtained through positioning.

In an example, the order processing module 54 is further configured to: obtain, in an entrance area, facial recognition data of the user who selects and purchases the commodity, where the facial recognition data corresponds to a user identifier of the user; and obtain facial recognition data again to obtain a user identifier corresponding to the facial recognition data when it is determined that the commodity and the user are in the exit area, where the order is an order of the user corresponding to the user identifier.

The apparatus or the module described in the previous implementations can be implemented by a computer chip or an entity, or implemented by a product having a specific function. A typical implementation device is a computer. A specific form of the computer can be a personal computer, a laptop computer, a cellular phone, a camera phone, a smartphone, a personal digital assistant, a media player, a navigation device, an e-mail transceiver device, a game console, a tablet computer, a wearable device, or a combination of any several devices in these devices.

For ease of description, the previous apparatus is described by dividing the functions into various modules. Certainly, when the present disclosure is implemented, the functions of each module can be implemented in one or more pieces of software and/or hardware.

For example, technical carriers related to the payment in this implementation of the present application can include near field communication (NFC), WIFI, 3G/4G/5G, a POS card swiping technology, a two-dimensional code scanning technology, a barcode scanning technology, Bluetooth, infrared, a short message service (SMS), and a multimedia message service (MMS).

The previous descriptions are merely examples of implementations of the present disclosure, but are not intended to limit the present disclosure. Any modification, equivalent replacement, or improvement made without departing from the spirit and principle of the present disclosure shall fall within the protection scope of the present disclosure.

As described herein, the present solution and description relates to implementations of automatic order tracking in a physical store. Implementations allow customers to walk into a physical store (for example, a grocery store or a convenience store, among others), take the commodities the customer would like to purchase (for example, from the shelf or from a display), and exit the store without queuing at checkout to pay. The customer's order is automatically recorded as they enter a designated exit area with the commodities they intend to purchase, and their account is automatically deducted as they exit the store. By tracking a customer and the commodities in their possession at an exit area, the process of determining an order is simplified. This solution avoids the numerous intermediate update steps required to update a customer order continuously as they select which commodities they want to purchase, and can limit such determinations to when the user is leaving the location, such as in a designated exit area of the location (for example, an exit, an area near a checkout counter or checkout line, etc.).

The proposed solution provides technical advantages in that commodity location can be more accurately tracked in a physical store by using a combination of human gesture recognition and position labels (for example, RFID tags). This accurate location tracking provides the ability to automatically track the commodities a user is leaving a shopping area with, even in complex environments with multiple users and multiple types of commodities. The solution allows for a faster, more enjoyable experience for the customer, who no longer has to wait in line and have their selected commodities manually added to their order. Additionally, the solution allows for easier prevention of shoplifters and simplified store inventory.

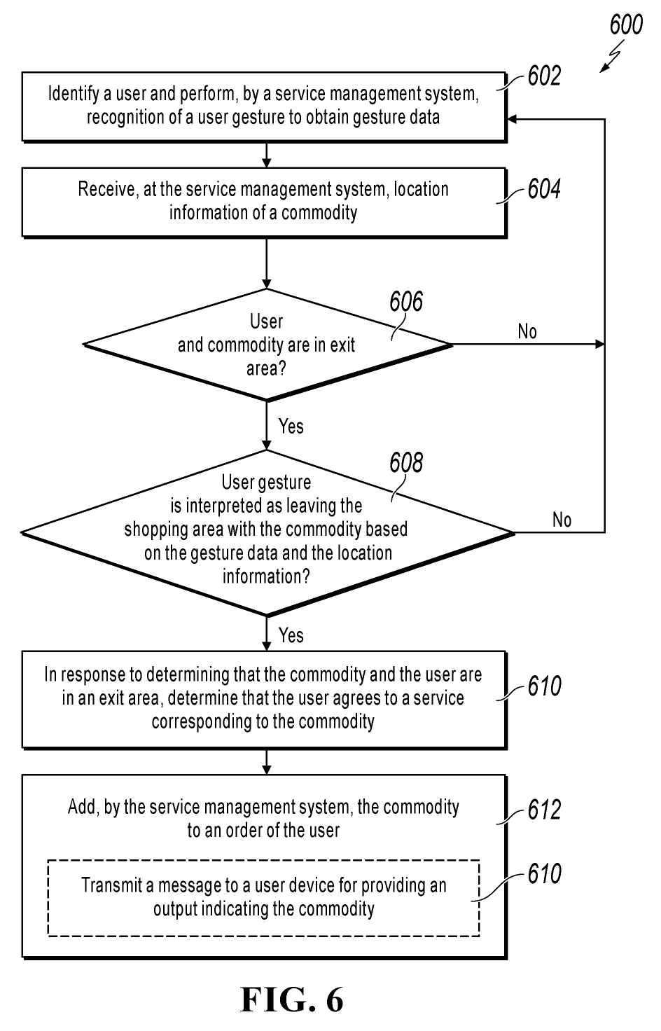

FIG. 6 is a flowchart illustrating an example of a computer-implemented method 600 for order information determination, according to an implementation of the present disclosure. For clarity of presentation, the description that follows generally describes method 600 in the context of the other figures in this description. However, it will be understood that method 600 can be performed, for example, by any system, environment, software, and hardware, or a combination of systems, environments, software, and hardware, as appropriate. In some implementations, various steps of method 600 can be run in parallel, in combination, in loops, or in any order.

At 602, a user is identified and the service management system performs recognition of a user gesture to obtain gesture data. The user can be identified by any suitable method, including, for example, using facial recognition software. In another instance, the user may be prompted by the service management system to provide user identification using a user device (for example, a cell phone, tablet, or other personal device, as well as dedicated devices location at or managed by the service management system, etc.). In some implementations, each user has a unique user identifier, which can be associated with a member identifier, and a payment account that corresponds to the member identifier. Gesture recognition can be performed by the service management system using, for example, video as an input. The video can be obtained using one or more cameras located in the environment. In some instances, the service management system can recognize major parts of the human body. Parts of the human body can be, but are not limited to arms, legs, chest, and hands. In these instances, a gesture can be recognized as a specific relationship between two or more body parts. For example, one gesture may be used to determine that the user puts their hands in front of their chest. Another gesture may be the user holding their hand down by their thigh. The service management system stores gesture data as a location relationship between the parts of the human body. From 602, method 600 proceeds to 604.

At 604, the service management system receives location information of one or more commodities. The commodities can be objects that the user intends to purchase. For example, a commodity can be food, a book, or a form of apparel, among other things. In one implementation, the location information of a commodity can be obtained using a positioning label attached to the commodity. The positioning label can be an RFID label. The positioning label can be scanned by various RFID readers throughout the store, and the location of the commodity can be determined and tracked by the service management system in real time. In another implementation, the positioning label may also contain information about the commodity. For example, the positioning label may also include commodity name, expiration date, price, or weight, among other things. From 604, method 600 proceeds to 606.

At 606, it is determined whether or not the user and the one or more commodities have entered an exit area. If the user is not in an exit area, method 600 returns to step 602. If the user and the commodities are located in an exit area, method 600 proceeds to 608.

At 608, a determination is made as to whether the user gesture is that of leaving a shopping area with the one or more commodities based on the gesture data and the location information. For example, if the user holds their hand in front of their chest, it may be that they are leaving the shopping area with a commodity. If it is determined based on the location information that a particular commodity is located in front of the user's chest, it can be determined that the user is leaving with the particular commodity. If it is otherwise determined that no commodity is in front of the users chest, it can be determined that the user gesture was not that of leaving the shopping area with a commodity. By using both gesture data and the location information of the commodity, the service management system can accurately determine if a user has possession of a commodity. This system is robust even in complex scenarios. For example, the system is able to correctly determine when multiple users leave with multiple commodities simultaneously, which user has which commodity. In another example, if a user places a commodity in the wrong location, such that the commodity is similar to, but not the same as the other commodities on the shelf, and then a subsequent user takes the similar commodity, the service management system will be able to use the location information of that commodity to ensure the correct commodity is added to the order. If it is determined that the gesture was that of is leaving with the commodity, method 600 proceeds to 610. Otherwise, if it is determined that the user did not take the commodity, method 600 returns to 602.

At 610, in response to determining the user is leaving a shopping area with the commodity, and the user and the commodity are in an exit area the service management system determines that the user agrees to a service corresponding to the commodity. The user's location can be determined using cameras or other sensor throughout the store. In some instances, gesture recognition can occur throughout the store. In other implementations, gesture recognition only occurs in the exit area. From 610, method 600 proceeds to 612.

At 612, in response to determining that the commodity and the user agrees to a service corresponding to the commodity, an order is generated, by the service management system including the one or more commodities. The service management system can then obtain payment for the commodity, which is automatically deducted from a payment account of the user. The payment account can be associated with a member ID of the user. In one implementation, the member ID can be obtained by the service management system from facial recognition in an entry area. In another implementation the service management system can transmit a message to a user device for providing an output indicating the commodity or commodities (614). The user device can be a cell phone, tablet, or other mobile device. The service management system can communicate with the user device via any suitable method. For example, the communications can be, but are not limited to, near field communications (NFC), WIFI, 3G/4G/5G, POS card swiping, Bluetooth, short message service (SMS), multimedia message service (MMS), two-dimensional code scanning technology, or barcode scanning technology, among other things. In this implementation the member ID can be received from the user device, via NFC, or another of the communication methods mentioned above. With the associated member ID, and upon recognizing that a user has entered the exit area with one or more commodities, the service management system can, for example, automatically deduct the balance of the order from the user's payment account. In another implementation, the service management system can prompt the user to confirm a payment total or the order. In this way, the user can directly leave the store, without queuing for checkout. From 612, method 600 stops.

Embodiments and the operations described in this specification can be implemented in digital electronic circuitry, or in computer software, firmware, or hardware, including the structures disclosed in this specification or in combinations of one or more of them. The operations can be implemented as operations performed by a data processing apparatus on data stored on one or more computer-readable storage devices or received from other sources. A data processing apparatus, computer, or computing device may encompass apparatus, devices, and machines for processing data, including by way of example a programmable processor, a computer, a system on a chip, or multiple ones, or combinations, of the foregoing. The apparatus can include special purpose logic circuitry, for example, a central processing unit (CPU), a field programmable gate array (FPGA) or an application-specific integrated circuit (ASIC). The apparatus can also include code that creates an execution environment for the computer program in question, for example, code that constitutes processor firmware, a protocol stack, a database management system, an operating system (for example an operating system or a combination of operating systems), a cross-platform runtime environment, a virtual machine, or a combination of one or more of them. The apparatus and execution environment can realize various different computing model infrastructures, such as web services, distributed computing and grid computing infrastructures.

A computer program (also known, for example, as a program, software, software application, software module, software unit, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A program can be stored in a portion of a file that holds other programs or data (for example, one or more scripts stored in a markup language document), in a single file dedicated to the program in question, or in multiple coordinated files (for example, files that store one or more modules, sub-programs, or portions of code). A computer program can be executed on one computer or on multiple computers that are located at one site or distributed across multiple sites and interconnected by a communication network.

Processors for execution of a computer program include, by way of example, both general- and special-purpose microprocessors, and any one or more processors of any kind of digital computer. Generally, a processor will receive instructions and data from a read-only memory or a random-access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data. A computer can be embedded in another device, for example, a mobile device, a personal digital assistant (PDA), a game console, a Global Positioning System (GPS) receiver, or a portable storage device. Devices suitable for storing computer program instructions and data include non-volatile memory, media and memory devices, including, by way of example, semiconductor memory devices, magnetic disks, and magneto-optical disks. The processor and the memory can be supplemented by, or incorporated in, special-purpose logic circuitry.

Mobile devices can include handsets, user equipment (UE), mobile telephones (for example, smartphones), tablets, wearable devices (for example, smart watches and smart eyeglasses), implanted devices within the human body (for example, biosensors, cochlear implants), or other types of mobile devices. The mobile devices can communicate wirelessly (for example, using radio frequency (RF) signals) to various communication networks (described below). The mobile devices can include sensors for determining characteristics of the mobile device's current environment. The sensors can include cameras, microphones, proximity sensors, GPS sensors, motion sensors, accelerometers, ambient light sensors, moisture sensors, gyroscopes, compasses, barometers, fingerprint sensors, facial recognition systems, RF sensors (for example, Wi-Fi and cellular radios), thermal sensors, or other types of sensors. For example, the cameras can include a forward- or rear-facing camera with movable or fixed lenses, a flash, an image sensor, and an image processor. The camera can be a megapixel camera capable of capturing details for facial and/or iris recognition. The camera along with a data processor and authentication information stored in memory or accessed remotely can form a facial recognition system. The facial recognition system or one-or-more sensors, for example, microphones, motion sensors, accelerometers, GPS sensors, or RF sensors, can be used for user authentication.

To provide for interaction with a user, embodiments can be implemented on a computer having a display device and an input device, for example, a liquid crystal display (LCD) or organic light-emitting diode (OLED)/virtual-reality (VR)/augmented-reality (AR) display for displaying information to the user and a touchscreen, keyboard, and a pointing device by which the user can provide input to the computer. Other kinds of devices can be used to provide for interaction with a user as well; for example, feedback provided to the user can be any form of sensory feedback, for example, visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments can be implemented using computing devices interconnected by any form or medium of wireline or wireless digital data communication (or combination thereof), for example, a communication network. Examples of interconnected devices are a client and a server generally remote from each other that typically interact through a communication network. A client, for example, a mobile device, can carry out transactions itself, with a server, or through a server, for example, performing buy, sell, pay, give, send, or loan transactions, or authorizing the same. Such transactions may be in real time such that an action and a response are temporally proximate; for example an individual perceives the action and the response occurring substantially simultaneously, the time difference for a response following the individual's action is less than 1 millisecond (ms) or less than 1 second (s), or the response is without intentional delay taking into account processing limitations of the system.

Examples of communication networks include a local area network (LAN), a radio access network (RAN), a metropolitan area network (MAN), and a wide area network (WAN). The communication network can include all or a portion of the Internet, another communication network, or a combination of communication networks. Information can be transmitted on the communication network according to various protocols and standards, including Long Term Evolution (LTE), 5G, IEEE 802, Internet Protocol (IP), or other protocols or combinations of protocols. The communication network can transmit voice, video, biometric, or authentication data, or other information between the connected computing devices.

Features described as separate implementations may be implemented, in combination, in a single implementation, while features described as a single implementation may be implemented in multiple implementations, separately, or in any suitable sub-combination. Operations described and claimed in a particular order should not be understood as requiring that the particular order, nor that all illustrated operations must be performed (some operations can be optional). As appropriate, multitasking or parallel-processing (or a combination of multitasking and parallel-processing) can be performed.

What is claimed is:

1. A computer-implemented method comprising:
performing, by a service management system, recognition of a user gesture, performed by a user, to obtain gesture data;
receiving, at the service management system, location information of a commodity;
determining, by the service management system, whether the user is leaving a shopping area with the commodity based on the gesture data and the location information; and
in response to the user gesture being interpreted as leaving the shopping area with the commodity, adding, by the service management system, information corresponding to the commodity to an order of the user.

2. The computer-implemented method of claim 1, wherein determining whether the user is leaving the shopping area with the commodity based on the gesture data and the location information comprises:
processing a label signal sent from a positioning label on the commodity to obtain location information of the commodity, wherein the label signal comprises commodity information of the commodity; and
determining, based on the gesture data, whether the commodity is in possession of the user by comparing a user body part in the gesture data with corresponding location information of the positioning label.

3. The computer-implemented method of claim 2, wherein the positioning label is a radio frequency identification label.

4. The computer-implemented method of claim 1, wherein determining whether the user is leaving the shopping area with the commodity based on the gesture data and the location information comprises:
determining whether the commodity and the user are in an exit area based on location information of the commodity and the user; and
in response to determining that the commodity and the user are in the exit area, determining that the user agrees to a service corresponding to the commodity.

5. The computer-implemented method of claim 4, further comprising:
obtaining, in an entrance area, facial recognition data of the user, wherein the facial recognition data corresponds to a user identifier of the user; and
obtaining, in the exit area, the facial recognition data to obtain the user identifier corresponding to the facial recognition data in response to determining that the commodity and the user are in the exit area, wherein the order corresponds to the user identifier.

6. The computer-implemented method of claim 1, further comprising:
in response to determining that the user is leaving the shopping area with the commodity based on the gesture data and the location information, transmitting a message to a user device for providing an output indicating the commodity.

7. The computer-implemented method of claim 6, wherein the service management system communicates with the user device by using a near field communication network.

8. The computer-implemented method of claim 6, further comprising:
receiving, by the service management system and from the user device, a user identifier.

9. The computer-implemented method of claim 8, further comprising:
determining, by the service management system, a member identifier based on the user identifier; and
in response to determining the member identifier, determining, by the service management system, an account corresponding to the member identifier.

10. The computer-implemented method of claim 1, wherein the user gesture is a user placing a hand near a thigh of the user.

11. A non-transitory, computer-readable medium storing one or more instructions executable by a computer system to perform operations comprising:
performing, by a service management system, recognition of a user gesture, performed by a user, to obtain gesture data;
receiving, at the service management system, location information of a commodity;
determining, by the service management system, whether the user is leaving a shopping area with the commodity based on the gesture data and the location information; and
in response to the user gesture being interpreted as leaving the shopping area with the commodity, adding, by the service management system, information corresponding to the commodity to an order of the user.

12. The computer-readable medium of claim 11, wherein determining whether the user is leaving the shopping area with the commodity based on the gesture data and the location information comprises:
processing a label signal sent from a positioning label on the commodity to obtain location information of the commodity, wherein the label signal comprises commodity information of the commodity; and
determining, based on the gesture data, whether the commodity is in possession of the user by comparing a user body part in the gesture data with corresponding location information of the positioning label.

13. The computer-readable medium of claim 12, wherein the positioning label is a radio frequency identification label.

14. The computer-readable medium of claim 11, wherein determining whether the user is leaving the shopping area with the commodity based on the gesture data and the location information comprises:
determining whether the commodity and the user are in an exit area based on location information of the commodity and the user; and
in response to determining that the commodity and the user are in the exit area, determining that the user agrees to a service corresponding to the commodity.

15. The computer-readable medium of claim 14, further comprising:
obtaining, in an entrance area, facial recognition data of the user, wherein the facial recognition data corresponds to a user identifier of the user; and
obtaining, in the exit area, the facial recognition data to obtain the user identifier corresponding to the facial recognition data in response to determining that the commodity and the user are in the exit area, wherein the order corresponds to the user identifier.

16. The computer-readable medium of claim 11, further comprising:
in response to determining that the user is leaving the shopping area with the commodity based on the gesture data and the location information, transmitting a message to a user device for providing an output indicating the commodity.

17. The computer-readable medium of claim 16, wherein the service management system communicates with the user device by using a near field communication network.

18. The computer-readable medium of claim 16, further comprising:
receiving, by the service management system and from the user device, a user identifier;
determining, by the service management system, a member identifier based on the user identifier; and
in response to determining the member identifier, determining, by the service management system, an account corresponding to the member identifier.

19. The computer-readable medium of claim 11, wherein the user gesture is a user placing a hand near a thigh of the user.

20. A computer-implemented system, comprising:
one or more computers; and
one or more computer memory devices interoperably coupled with the one or more computers and having tangible, non-transitory, machine-readable media storing one or more instructions that, when executed by the one or more computers, perform one or more operations comprising:
performing, by a service management system, recognition of a user gesture, performed by a user, to obtain gesture data;
receiving, at the service management system, location information of a commodity;
determining, by the service management system, whether the user is leaving a shopping area with the commodity based on the gesture data and the location information; and
in response to the user gesture being interpreted as leaving the shopping area with the commodity, adding, by the service management system, information corresponding to the commodity to an order of the user.
